(19) United States
(12) Patent Application Publication
(10) Pub. No.: US 2007/0111855 A1
(43) Pub. Date: May 17, 2007

(54) Engine speed-dependent pressure regulation of oil pumps

(76) Inventor: Dieter Voigt, Braunschweig (DE)

Correspondence Address: ECKERT SEAMANS CHERIN & MELLOTT, 600 GRANT STREET, 44TH FLOOR, PITTSBURGH, PA, 15219, US

(21) Appl. No.: 10/581,148

(22) PCT Filed: Nov. 29, 2004
(86) PCT No.: PCT/IB04/03910

§ 371 Date: Jan. 8, 2007

(30) Foreign Application Priority Data
Dec. 10, 2003 (DE) 103 57 619.3
Feb. 14, 2004 (DE) 102004 007 323.6
Mar. 16, 2004 (DE) 102004 012 726.3

(51) Int. Cl. F16H 61/26

(52) U.S. Cl. 477/156

(57) ABSTRACT

An engine speed-dependent oil pressure regulation of control oil pumps for the lubricant supply of internal combustion engines is ensured by a control piston that hydraulically controls the delivery regulation and to which a differential pressure piston applies a variable additional force. For this purpose, a centrifugal force which is generated in a radial bore of a rotating conveyor wheel of the control oil pump and is variable as a function of engine speed is applied to the differential pressure piston.

### FIELD OF THE INVENTION

The invention concerns the regulation of the conveying pressure of hydraulic pumps. It relates particularly to a speed dependent pressure regulation for so-called oil control pumps for the lubricating oil supply of internal combustion engines which comprise a conveying capacity adjusting device and, for biasing it with pressure, a control piston for generating a control pressure, which may be biased by a device providing a variable additional force for varying the conveying pressure.

### BACKGROUND OF THE INVENTION

Hydraulic pumps of controllable conveying capacity need a reduced oil pump driving power, as compared with hydraulic pumps using a by-pass regulation, and are already used with a constantly controlled conveying pressure as so-called oil control pumps for the lubricating oil supply of internal combustion engines.

But only by a speed-dependent pressure regulation of oil control pumps in accordance with the oil pressure need of internal combustion engines, which is speed-dependent to a large extent, the potential of improvement of oil control pumps can almost completely be utilized. As a consequence of a reduction of the hydraulic conveying power, which is considerable by then, the resulting advantages of the driving power of oil control pumps are enabled to cause a contribution worth mentioning to a consumption reduction in internal combustion engines.

An oil control pump having a variable oil pressure regulation is known from Patent No. DE 102 37 911 B4 and is also described in WO 03/058071. In the first case, it is constructed as an external teeth wheel pump comprising a displacement unit using an axially variable tooth engagement width that effects the adjustment of the conveying capacity. The regulation of the operational oil pressure is effected over the variable conveying capacity, the axially variable position of the displacement unit being adjusted by a control pressure acting onto it which is provided by a control piston. The control piston comprises a control spring and is biased so as to counter-act to it by the operational oil pressure and, thus, functions as an oil pressure sensor which is dimensioned for a corresponding nominal operational oil pressure. Communicating with oil bores, it comprises control grooves which generate the control pressure for biasing the displacement unit. Due to an additional variable biasing force onto the control piston by a control device, the operational oil pressure may either be adapted in steps or continuously to the oil pressure need of the internal combustion engine to be lubricated, which is speed-dependent to a large extent.

An embodiment of the DE 102 37 911 B4 shows changing over in two steps of the operational oil pressure by a switching valve actuated by centrifugal force acting in a speed-de-pendent manner. In another embodiment, a continuously variable regulation of the operational oil pressure is effected by an electrical adjusting device of the control piston which, in turn, is controlled by the control appliance of the internal combustion engine. A further embodiment comprises a spiral groove on a rotating shaft, where oil sharing forces dependent on the number of revolutions generate a pressure for oil pressure regulation which biases the control piston.

While a regulation of the operational oil pressure in steps makes only limited use of the improvement potential of an oil control pump, an advantageous continuous regulation of the operational oil pressure involves either a higher electrical control expenditure or, in the case of a spiral pressure regulation, is only usable in a limited temperature range due to the oil viscosity which varies with temperature.

### SUMMARY OF THE INVENTION

The invention has the object to provide an oil pressure regulation for an oil control pump, which adapts continuously the operational oil pressure to the oil pressure needs of an internal combustion engine, which is substantially speed-dependent, without requiring an electrical control expenditure or without temperature-dependent limitations.

This object is achieved according to the invention in a second step according to the invention in a simple manner in that the control piston of an oil control pump is biased both with the operational oil pressure and with an additional centrifugal pressure which is generated in dependence upon the centrifugal force by an oil column in a rotating radial bore in a speed-dependent manner.

### BRIEF DESCRIPTION OF THE DRAWINGS

Details of the invention will become apparent from the following description of embodiments schematically illustrated in the drawings, in which:

FIG. 1: shows an oil regulating pump with an external teeth wheel according to the invention, which comprises a control piston that is situated within a pump housing;

FIG. 2: is an oil pressure plot of the oil pressure need of an internal combustion engine, and the course of oil pressure of a oil control pump according to the invention;

FIG. 3: illustrates an oil regulating pump with an external teeth wheel according to FIG. 1, where the control piston, however, comprises a non-interacting differential pressure piston;

FIG. 4: represents a detail of an oil regulating pump with an external teeth wheel comprising the arrangement of the oil pressure regulation according to the invention in its displacement unit;

FIG. 5: is an arrangement, alternative to that of FIG. 4, of a solenoid valve for increasing the oil pressure.

### DETAILED DESCRIPTION OF THE DRAWINGS

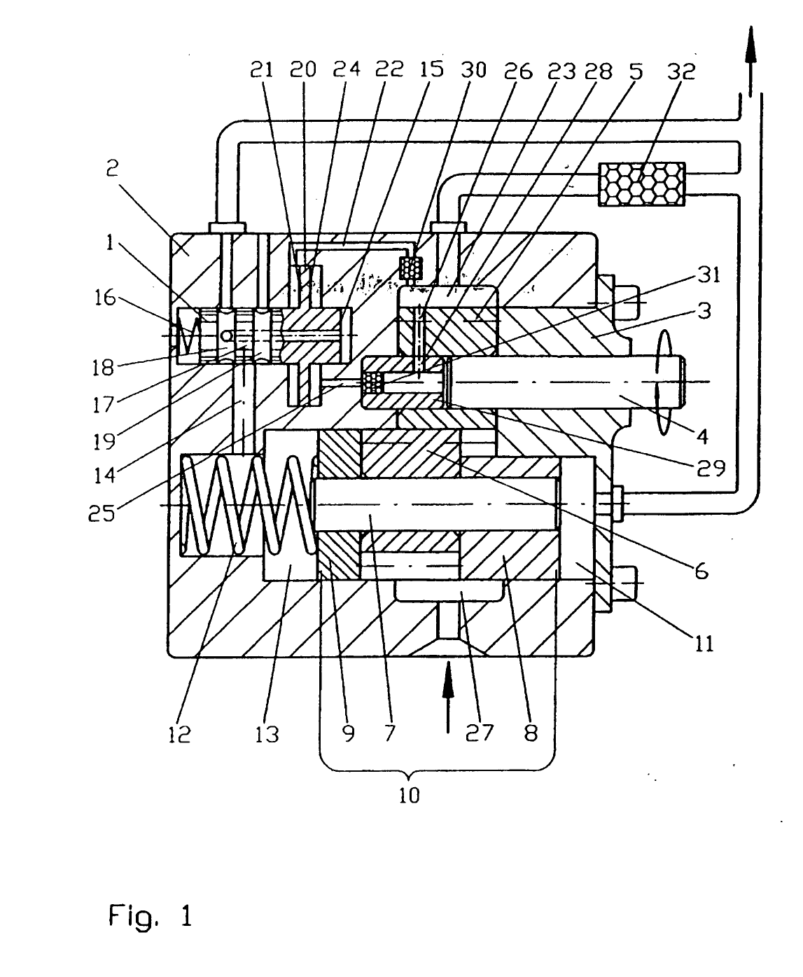

FIG. 1 shows a first embodiment of an oil regulating pump with an external teeth wheel according to the invention for an internal combustion engine, where an oil pressure regulation is effected by a control piston 1 arranged in a pump housing 2. A driving shaft 4 supported in a housing cover 3 supports a first conveying wheel 5 in toothed engagement with a second conveying wheel 6. The conveying wheel 6 is supported by a stationary journal bolt 7 which, on the right side of the conveying wheel 6, supports a pressure piston 8 and, on the left side, a spring biased piston 9. The assembly of the pressure piston 8, journal bolt 7 and conveying wheel 6 as well as of spring biased piston 9 forms a displacement unit 10. By axially displacing the displacement unit 10, the tooth engagement width of the conveying wheels 5 and 6 can be varied by which fact a variation of the conveying capacity of the oil control pump is enabled in a known manner.

The axial displacement of the displacement unit 10 is effected as a function of forces which act onto it from the exterior. While the pressure piston 8 is constantly biased by the operational oil pressure acting in its chamber 11, which in this embodiment is callipered behind an oil filter 32 as the supply pressure for the internal combustion engine, the force of a reset spring 12 and the pressure force of a control pressure prevailing in the spring chamber 13 act onto the spring biased piston 9. The control pressure is generated to meet the needs in a known manner by the control piston 1 and is fed into the spring chamber 13 through a control bore 14.

The control piston 1 is constantly biased on its front-sided effective surface 15 via its central bore by the operational oil pressure. A control spring 16, counteracting the operational oil pressure, of the control piston 1 is dimensioned for a predetermined basic operational oil pressure of, for example, 1.0 bar. By a trunnion portion 17 of the control piston 1 and a pressure groove 18 on the left side, which is biased by the operational oil pressure, and a relief groove 19 on the right side, which communicates with ambient, an appropriate control pressure to the spring chamber 13 is adjusted through the control bore 14, as is known per se. This control pressure adjusts the conveying capacity required for a certain nominal operational oil pressure by axial positioning of the displacement unit 10.

In the case that the oil pressure deviates from the nominal operational oil pressure, for example due to a change of the number of revolutions of the internal combustion engine and the, thus, at first changing conveying capacity of the pump, the control piston 1, working as an oil pressure sensor, answers with a corresponding axial displacement so that the control pressure prevailing in the spring chamber 13 is either increased or decreased, and an adaptation of the conveying capacity to the nominal operation oil pressure will be effected for the purpose of an oil pressure correction.

For changing the nominal operational oil pressure to adapt it to the speed-dependent variable oil pressure need of the internal combustion engine, the control piston 1 is biased with an additional force. To this end, it comprises, according to the invention, a differential pressure piston 20. While a reference pressure surface 21 of the differential pressure piston 20, through a pressure connection 22, is constantly biased by the conveying pressure prevailing in a pressure chamber 23 of the pump housing 2, a centrifugal pressure surface 24, opposite the reference pressure surface 21, communicates the pressure hydraulically through a pressure connection 25 to the inner end of a radial bore 26 of the rotating conveying wheel 5. The radial bore 26, which ends radial externally in a tooth head of the rotating conveying wheel 5, in the rotational angular position shown of the conveying wheel 5, is biased with the conveying pressure of the pressure chamber 23.

The centrifugal action of the oil in the radial bore 26 generates a radial externally directed, speed-dependent centrifugal pressure so that the conveying pressure, which acts from the pressure chamber 23 onto the radial bore 26 at its radial inner end is reduced by the centrifugal pressure. The centrifugal pressure, which is effectively only acting onto the differential pressure piston 20, because the conveying pressure which acts on both sides onto it compensates itself, exerts a speed-dependent additional force, which assists the control spring 16 and which depends also upon the dimension of the differential pressure piston 20. This additional force enables a control function of the control piston 1 for the control pressure acting in the spring chamber 13 only with a correspondingly increased operational oil pressure biasing the effective surface 15.

Since the radial bore 26 in the rotating conveying wheel 5, in dependence on the rotating angle, gets also into contact with regions of the pump housing 2, which are not biased by the conveying pressure, for example with the joining cross-sections of a suction chamber 27 not shown in the drawing, the pressure connection between the radial bore 26 and the centrifugal pressure surface 24 is only possible through a transverse connection 28 of a stationary journal bolt 29 which is oriented to the pressure chamber 23.

By a higher number of radial bores in the conveying wheel 5, for example one radial bore 26 each per conveying tooth, a more effective, and with a permanent overlap with the transverse connection 28 even a maximum centrifugal effect, can be achieved on the differential pressure piston 20.

The two pressure connections 22 and 25 of the differential pressure piston 20 or even the journal bolt 29 may contain filters, for example the filters 30 and filter 31, for avoiding pollution-caused malfunctions.

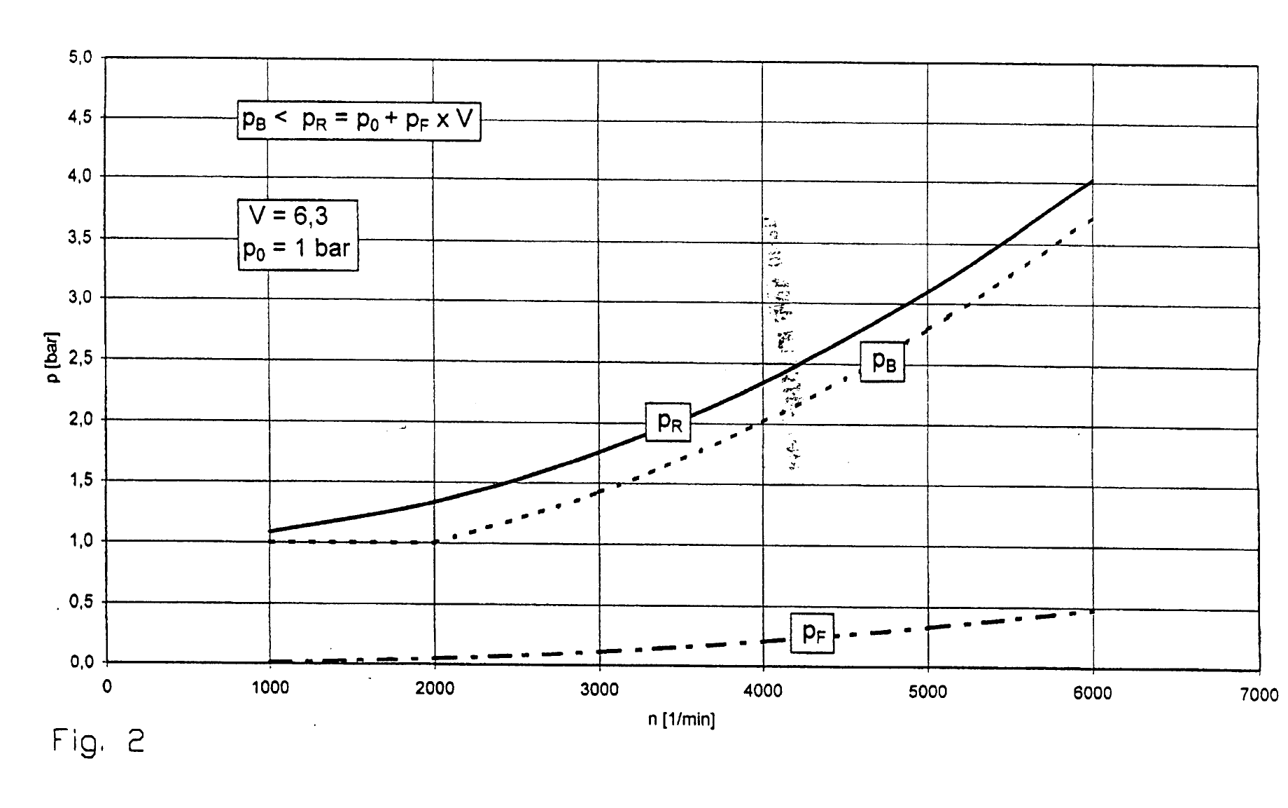

FIG. 2 shows an oil pressure plot for an internal combustion engine having an oil supply by an oil control pump 1 illustrated in FIG. 1. The speed-dependent oil pressure need p_{B} of the internal combustion engine amounts, for example, to 1.0 bar in minimum up to an engine number of revolutions n=2000 rpm, and then increases in the shape of a parable with raising number of revolutions up to 3.7 bar at 6000 rpm.

The control spring 16 of the control piston 1 (FIG. 1) is dimensioned for a predetermined basic operational oil pressure p₀ which, with a low number of revolutions without an effective centrifugal pressure action, amounts at the differential pressure piston 20, for example, to p₀=1.0 bar as the minimum admissible operational oil pressure for the internal combustion engine.

The centrifugal pressure p_{F} generated in the radial bore 26 increases with the number of revolutions of the engine in the shape of a parable, reaching, however, according to FIG. 2 only about 0.5 bar at a maximum motor speed of n=6000 rpm due to the relative compact dimensions of the conveying wheel 5. Due to the relative large effective area of the differential pressure piston 20 for the centrifugal pressure p_{F}, corresponding amplifying factor of V=6.3 is achieved so that the centrifugal pressure p_{F} generated in the radial bore 26, which is only small, exerts a sufficiently high additional force onto the control piston 1. This additional force of the differential pressure piston 20, which assists the force of the control spring 16, adjusts finally the operational oil pressure p_{R} of the internal combustion engine, which is, according to the invention, regulated in a speed-dependent manner by the oil control pump, and which may be calculated with the formula
p_{R}=p₀+p_{F}×V.

The operational oil pressure p_{R} must always be larger than the oil pressure need p_{B} of the internal combustion engine.

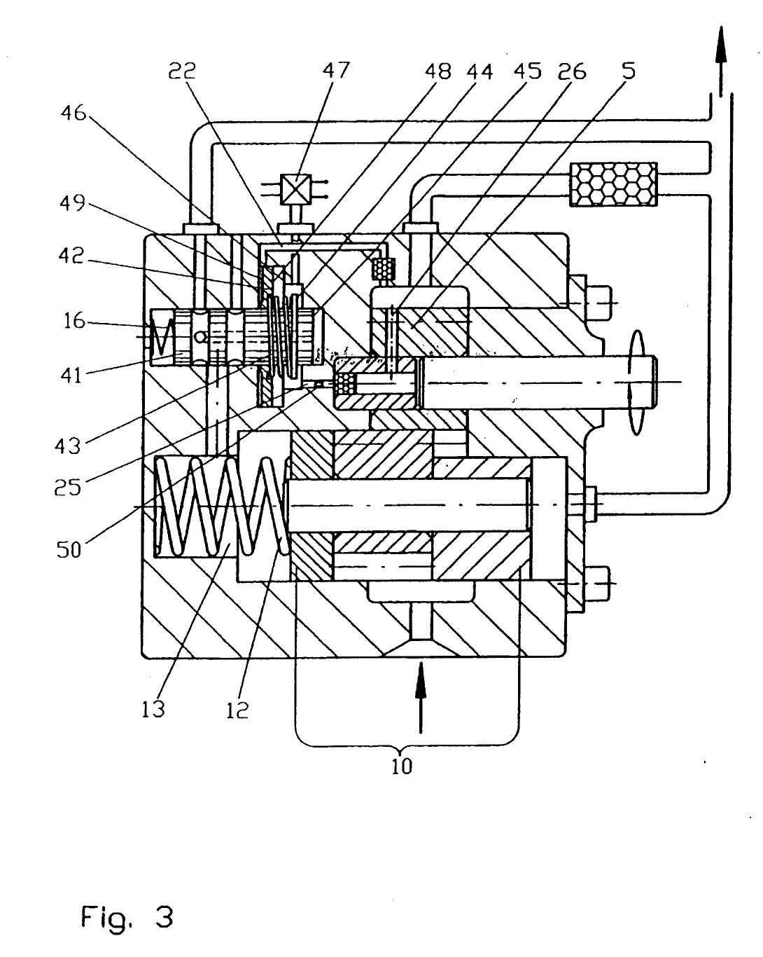

A further embodiment of a control pump, shown in FIG. 3, comprises a modified control piston 41, as compared with the embodiment of FIG. 1. It comprises a differential pressure piston 42 axially displaceable on it, which transfers the additional force resulting from the centrifugal pressure in the radial bore 26 of the conveying wheel 5, via a spring 43 and a spring abutment 44 to the control piston 41.

Due to the, now, soft coupling of the differential pressure piston 42 to the control piston 41 by the spring 43, it is only a very small damping effect of the differential pressure piston 42 having a relative large area which is achieved so that the control piston 41 may answer to all occurring deviations form the nominal operational oil pressure, in contrast to the differential pressure piston 20 of FIG. 1 which is rigidly coupled to the control piston 1.

With a low number of revolutions without an effective centrifugal pressure, the spring 43 is almost force-less and engages the differential pressure piston in a relieved manner. With a centrifugal pressure increased with raising speed, the differential pressure piston 42 displaces under increasing tension of the spring 43 to the right, whereby a corresponding additional force is transferred to the control piston 41. As a desired consequence, the regulation of the operational oil pressure, that biases the effective surface 45, occurs in the above-mentioned manner only with a correspondingly raised pressure level.

A stop member 46 acting for the differential pressure piston 42, delimits, via the maximum stress of the spring 43, the additional force to be transferred to the control piston 41 so that the maximum operational oil pressure is then limited, for example to 5 bar.

By the speed-dependent centrifugal pressure control of the oil control pump, the operational oil pressure is enabled to be adapted to a large extent to the oil pressure need of an internal combustion engine to be supplied so that corresponding advantages of the driving performance will result from the oil pressure minimization. In the case of an increased oil pressure need of the internal combustion engine, for example for quickly actuating a hydraulic camshaft adjuster, a pressure relief may be attained at the centrifugal pressure surface 48 of the differential pressure piston 42, which is normally biased by the centrifugal pressure, by a solenoid valve 47, controlled by an engine control appliance. The conveying pressure, which acts always onto the reference pressure surface 49 of the differential pressure piston 42, shifts then the differential pressure piston 42 towards its stop 46 so that the spring 43 is in maximum stress, whereupon an increased operational oil pressure of, for example, 5 bar is regulated independently from speed. A throttle 50 situated in the pressure connection 25, with controlled solenoid valve 47, effects a more effective pressure reduction at the centrifugal pressure surface 48 of the differential pressure piston 42.

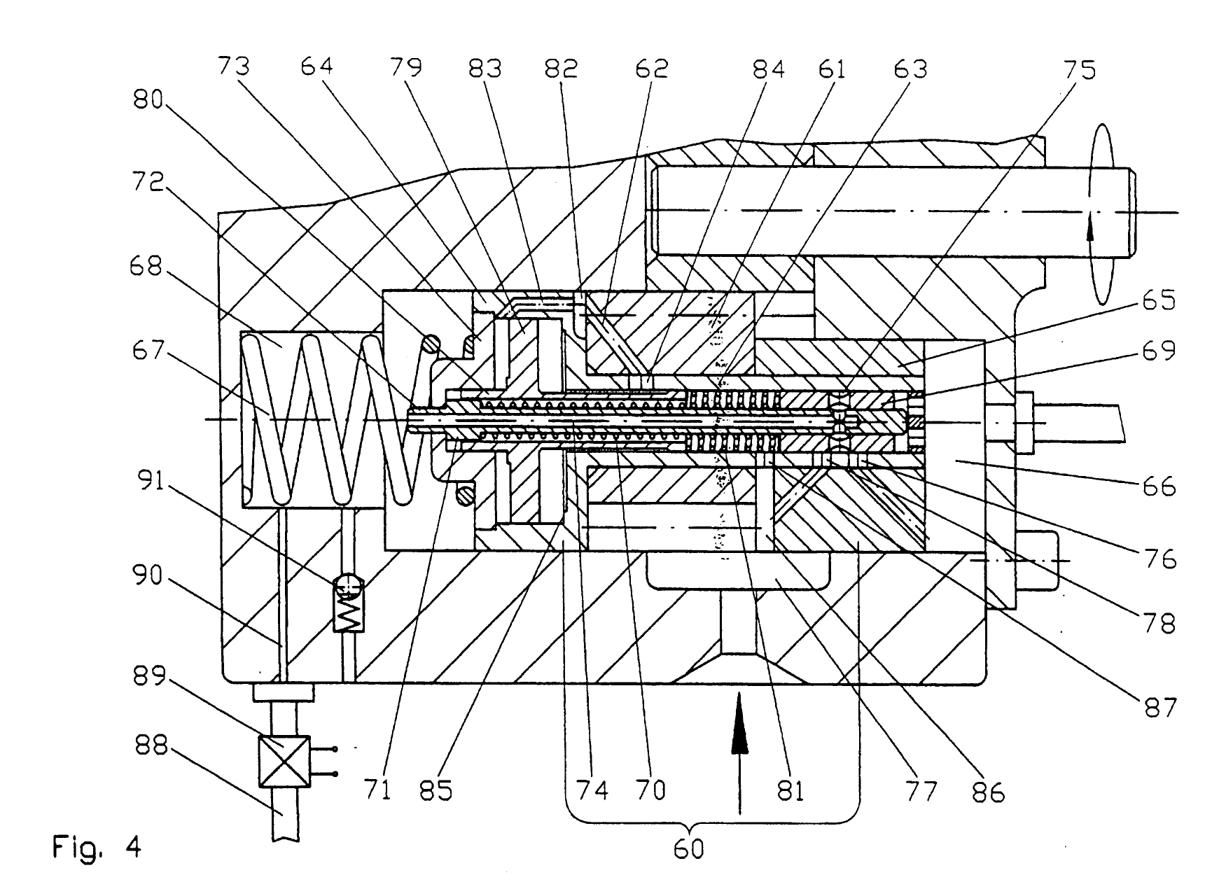

As an alternative to the arrangement of the control piston according to the invention in a pump housing, in correspondence to the embodiments of FIGS. 1 and 3, in the case of a control pump with an external teeth wheel, an arrangement of the control piston within the displacement unit, which effects the change of the conveying capacity, is also possible. In this way, a very compact oil control pump comprising a simple pump housing may be realized. In this context, FIG. 4 shows a preferred embodiment of a displacement unit 60 as an enlarged detail of an oil control pump with an external teeth wheel.

The displacement unit 60 comprises a conveying wheel 61 having a radial bore 62 which extends inclined to the centrifugal direction and generates the centrifugal pressure. The conveying wheel 61 is supported on a hollow journal bolt 63 which is made in one piece with a spring piston 64. Opposite the spring piston 64, the displacement unit 60 is completed by a pressure piston 65 fixed on the journal bolt. The axial position of the displacement unit 60 and, thus, the respective conveying capacity of the control pump with external teeth wheel, is dependent upon the operational oil pressure that acts onto the pressure piston 65 in its chamber 66, on the one hand, and upon the opposing forces at the spring piston 64, on the other hand, which are generated by a reset spring 67, on the one hand, and by the control pressure that acts in its spring chamber 68, on the other hand.

The control pressure, in this embodiment, is generated by an annular control piston 69 which is situated within the journal bolt 63 and is biased, at one end, by the operational oil pressure prevailing in the chamber 66, while propping against a control spring 70 at the other end. The latter rests on a collar 71 of a pressure pipe 72 which, through its central bore 74, feeds the control pressure generated by the control piston 69 into the spring chamber 68. The collar 71 on the pressure pipe 72 props against a cover 73 fixed to the spring piston 64. The pressure pipe 72 sealingly penetrates the control piston 69 with a close sliding fit. Its central bore 74, which is closed at its end facing the chamber 66 is continuously in pressure connection with a groove 75 of the control piston 69, for example through appropriate transversal bores in the pressure pipe 72 and in the control piston 69.

The groove 75 of the control piston 69, in the middle control position shown, overlaps slightly both a pressure bore 76 fed with the operational oil pressure from the chamber 66, and a relief bore 78, that communicates with a suction chamber 77. Deviations from the nominal operational oil pressure, which acts from the chamber 66 onto the front surface of the control piston 69, are automatically corrected in the abovementioned manner by an axial control movement of the control piston 69 and by means of the control pressure which prevails in the spring chamber 68 by an axial displacement of the displacement unit 60 that controls the conveying capacity.

Within the spring piston 64 is a differential pressure piston 79, which is axially movably supported by a guide sleeve 80 in the cover 73 and in the journal bolt 63, and which, according to the invention, is able to transfer elastically an additional force onto the control piston 69 via a spring 81. The conveying pressure of the oil control pump, which continuously acts in a pressure pocket 82 of the spring piston 64, biases, in principle, both sides of the differential pressure piston 79, i.e. through a connection 83 of the spring piston 64, on the one hand, and through the inclined radial bore 62 of the conveying wheel 61, an oriented transversal bore 84 in the journal bolt 63 as well as by a local radial clearance between the guide sleeve 80 and the journal bolt 63. This conveying pressure is, however, reduced in the radial bore 62 by the centrifugal pressure acting in dependence on speed so that it is only the centrifugal pressure which generates effectively an additional force on the differential pressure piston 79.

This additional force generated by the differential pressure piston 79, when it engages a stop 85, is by then limited by the maximum stress of spring 81 so that the adjusted maximum operational oil pressure of the control pump is then limited, for example, to 5 bar.

In order to achieve a perfect function of the regulation, the hollow spaces in the journal bolt 63 have to be depressurized. To this end, the pressure piston 65 comprises a suction pocket 86, that communicates with the suction chamber 77, which causes a pressure relief of these hollow spaces through a relief bore 87 of the journal bolt 63.

With an arrangement of the control piston 69 within the displacement unit 60, a temporal increase of the operational oil pressure, in the case of an increased oil pressure need of the internal combustion engine, is also possible. To this end, a conduit 88 which is under the operational oil pressure comprises a solenoid valve 89 which, being electrically controlled by the engine control appliance, effects an increase in pressure through a throttle bore 90, thus being superimposed to the control pressure of the spring chamber 68. In this way, the displacement unit 60 is shifted to the right and into a position of an increased oil conveying capacity by the reset spring 67 so that an increase of the operational oil pressure will result. However, a pressure relief valve 91 limits the pressure in the spring chamber 68 to a predetermined value so that the operational oil pressure prevailing in the chamber 66 can only rise up to a corresponding maximum value. With this maximum operational oil pressure, by then being independent from the number of revolutions, the oil control pump works further with an active regulation of conveying capacity, while the control piston 69 is then out of function.

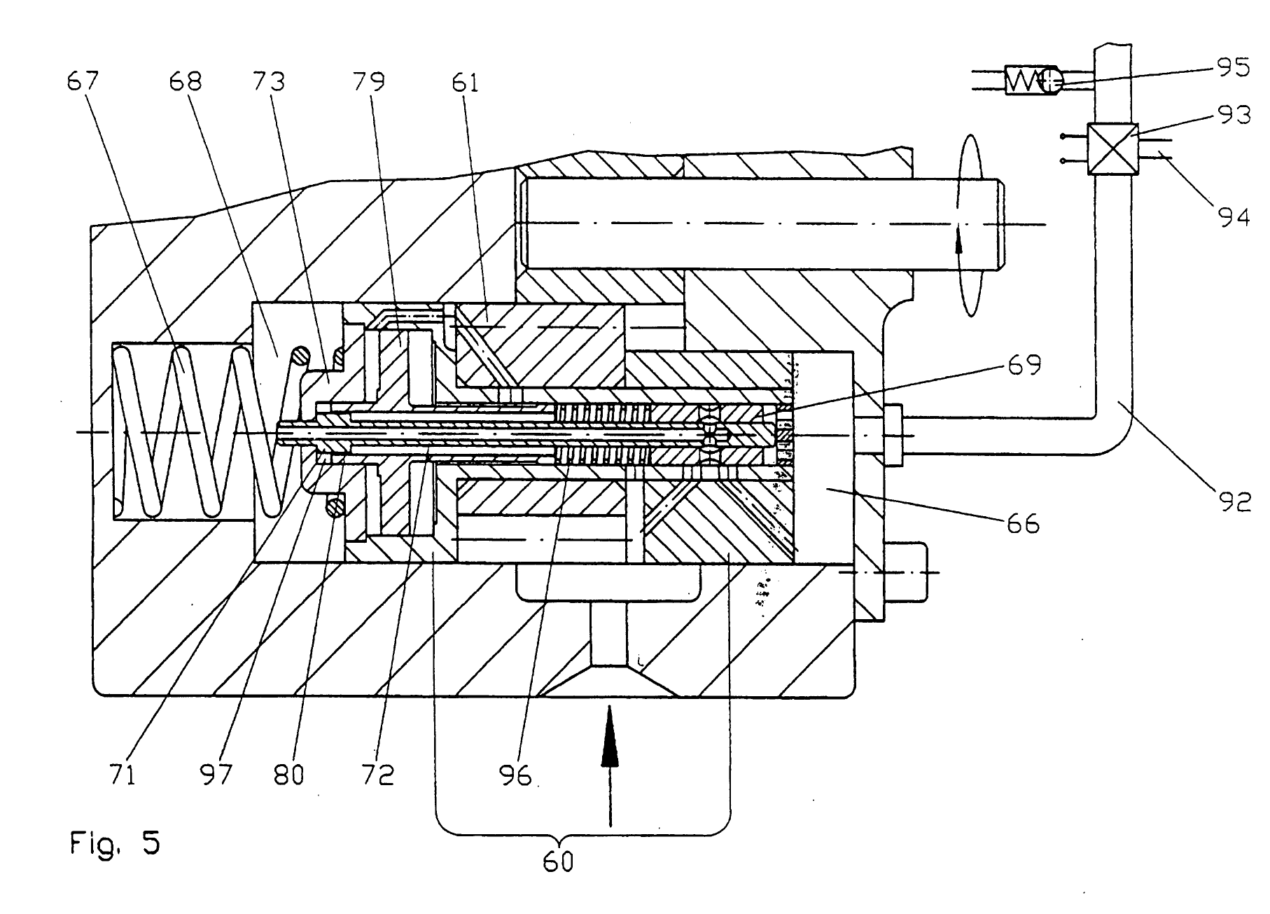

As an alternative to FIG. 4, FIG. 5 shows another possibility of an embodiment of a control pump with external teeth wheel embodying a centrifugal pressure regulation integrated into the displacement unit 60. In a supply conduit 92, which feeds the operational oil pressure into the chamber 66, there is a solenoid valve 93 which is closed, when the engine control appliance demands an increase of the operational oil pressure, and which, at the same time, relieves the chamber 66 from pressure through a connection piece 94. The reset spring 67 moves then the displacement unit 60 into the position of maximum conveying capacity, which will result in an increase of the operational oil pressure. Due to the fact that the regulation of conveying capacity is then inactive, a usual by-pass regulation comprising a pressure relief valve 95 must then be provided for limiting the maximum operational oil pressure, for example to 6 bar.

In FIG. 5, and in contrast to FIG. 4, the control piston 69, biased by the operational oil pressure form the chamber 66, props against the differential pressure piston 79 only via a pre-stressed control spring 97.

In comparison with the embodiment of FIG. 4, this simplified embodiment has, however, a somewhat different control characteristic as a consequence, because the additional force, generated by centrifugal pressure on the differential pressure piston 79, can only influence the pressure regulation from a certain operational number of revolutions on, thereby overcoming the pre-stressing force of the control spring 96.

An oil-filled throttle chamber 97, formed between the cover 73 of the guide sleeve 80 of the differential pressure piston 79 and the collar 71 of the pressure pipe 72, with an appropriate choice of the clearance between the guide sleeve 80 and the collar 71, may dampen the movement of the differential pressure piston 79. In this way, one avoids particularly a transfer of quick control movements of the control piston 69 through its elastic coupling to the differential pressure piston 79, so that with an appropriate dampening it remains in almost unchanged position, thus enabling a stable regulation function.

The control device according to the invention uses the centrifugal pressure generated in oil-filled radial bores of rotating components due to the centrifugal force in order to establish a speed-dependent regulation of the oil pressure in oil control pumps. In this way, with all operational temperature, a consumption-favorable reduction of oil pump driving power for internal combustion engines is achieved.

1.-10. (canceled)

11. An arrangement for speed-dependent pressure regulation of an oil control pump for pumping lubricating oil from an inlet space into a conveying pressure space and from there to an internal combustion engine, comprising
conveying capacity adjusting means for said lubricating oil supply;
a control piston for generating a control pressure to provide a pressure bias for said conveying capacity adjusting means;
means for applying an additional force that acts upon said control piston, said force applying means including
rotary means having a radial bore in communication with said lubricating oil so that said lubricating oil is subjected to the speed-dependent centrifugal pressure in said radial bore, and
a differential pressure piston having a first surface area biased by said lubricating oil under a first pressure influenced by said centrifugal pressure and a second surface area biased by said lubricating oil under a second pressure.

12. Arrangement as claimed in claim 11, wherein said radial bore extends in the direction of centrifugal force.

13. Arrangement as claimed in claim 11, wherein said radial bore is inclined to the direction of centrifugal force.

14. Arrangement as claimed in claim 11, wherein said rotary means is a conveying wheel of said oil control pump.

15. Arrangement as claimed in claim 11, further comprising pressure communication means for interconnecting said second surface area with said conveying pressure space so that said second pressure is the conveying pressure.

16. Arrangement as claimed in claim 11, wherein said first surface area is in communication with the radial inner end of said radial bore so that first pressure is the conveying pressure reduced by said centrifugal pressure.

17. Arrangement as claimed in claim 11, further comprising dampening means for dampening the movement of said differential pressure piston.

18. Arrangement as claimed in claim 17, wherein said dampening means comprise throttle means for throttling the flow of said lubricating oil moved by said differential pressure piston.

19. Arrangement as claimed in claim 18, wherein said throttle means comprise a throttle chamber, said differential pressure piston comprising a third surface area facing said throttle chamber.

20. Arrangement as claimed in claim 11, further comprising pressure relief means communicating with said first surface area of said differential pressure piston.

21. Arrangement as claimed in claim 20, wherein said pressure relief means comprise switching means.

22. Arrangement as claimed in claim 20, wherein said pressure relief means comprise a solenoid valve.

23. An arrangement for speed-dependent pressure regulation of an oil control pump for pumping lubricating oil into a conveying pressure space and from there to an internal combustion engine, comprising
conveying capacity adjusting means for said lubricating oil supply;
a control piston for generating a control pressure to provide a pressure bias for said conveying capacity adjusting means;
means for applying an additional force that acts upon said control piston, said force applying means including
rotary means having a radial bore in communication with said lubricating oil so that said lubricating oil is subject to the speed-dependent centrifugal pressure in said radial bore, and
a differential pressure piston having a first surface area biased by said lubricating oil under a first pressure influenced by said centrifugal pressure and a second surface area biased by said lubricating oil under a second pressure, said differential pressure piston being axially movable relative to said control piston; and
spring means acting onto said differential pressure piston and said control piston so that said differential pressure piston transfers said additional force to said control piston via said spring means.

24. Arrangement as claimed in claim 23, wherein said spring means comprise a first and a second spring which bias said control piston in the same direction, said second spring means being interposed between said control piston and said differential pressure piston.

25. An arrangement for speed-dependent pressure regulation of an oil control pump for pumping lubricating oil from an inlet space into a conveying pressure space and from there to an internal combustion engine, comprising
conveying capacity adjusting means for said lubricating oil supply;
a control piston for generating a control pressure to provide a pressure bias for said conveying capacity adjusting means, said control piston being housed by said conveying capacity adjusting means which prove a housing for it;
means for applying an additional force that acts upon said control piston, said force applying means including
rotary means having a radial bore in communication with said lubricating oil so that said lubricating oil is subjected to the speed-dependent centrifugal pressure in said radial bore, and
a differential pressure piston having a first surface area biased by said lubricating oil under a first pressure influenced by said centrifugal pressure and a second surface area biased by said lubricating oil under a second pressure.

26. Arrangement as claimed in claim 25, further comprising pressure channel means interconnecting the interior of said housing with said conveying pressure space, and relief channel means interconnecting the interior of said housing with said inlet space, wherein said control piston comprises a control groove which in a middle control position overlaps slightly both said pressure channel means and said relief channel means.

27. An arrangement for speed-dependent pressure regulation of an oil control pump for pumping lubricating oil from an inlet space into a conveying pressure space and from there to an internal combustion engine, comprising
conveying capacity adjusting means for said lubricating oil supply;
a control piston for generating a control pressure to provide a pressure bias for said conveying capacity adjusting means;
means for applying an additional force that acts upon said control piston, said force applying means including
a conveying wheel of said oil control pump for conveying said lubricating oil from said inlet space to said conveying pressure space, while imparting it a conveying pressure, said conveying wheel having a radial bore in communication with said lubricating oil so that said lubricating oil is subjected to the speed dependent centrifugal pressure in said radial bore, and
a differential pressure piston having a first surface area biased by said lubricating oil under a first pressure influenced by said centrifugal pressure and a second surface area biased by said lubricating oil under a second pressure,
wherein said radial bore of said rotating conveying wheel communicates only in predetermined angular positions with said first surface area of said differential pressure piston.

28. Arrangement as claimed in claim 27, further comprising stationary hollow bolt means for supporting said rotating conveying wheel, said hollow bolt means comprising a radial extending transverse channel leading from the periphery into the interior of said hollow bolt means, said radial bore of said conveying wheel, thus, communicating only in predetermined angular positions through said transverse channel with said first surface area of said differential pressure piston.

29. Arrangement as claimed in claim 27, further comprising filter means for said lubricating oil when flowing to at least one of said first and second surface areas.

30. Arrangement as claimed in claim 27, further comprising throttle means for said lubricating oil when flowing to at least one of said first and second surface areas.

31. An arrangement for speed-dependent pressure regulation of an oil control pump for pumping lubricating oil from an inlet space into a conveying pressure space and from there to an internal combustion engine, comprising
pump housing means;
conveying capacity adjusting means for said lubricating oil supply, said conveying capacity adjusting means being displaceable as a displacement unit in said pump housing means;
reset means for urging said displacement unit against the pressure of said conveying pressure space;
a control piston for generating a control pressure to provide a pressure bias for said conveying capacity adjusting means;
means for applying an additional force that acts upon said control piston, said force applying means including
a conveying wheel of said oil control pump having external conveying teeth conveying lubricating oil from said inlet space to said conveying pressure space, while imparting it a conveying pressure, said conveying wheel having a radial bore in communication with said lubricating oil so that said lubricating oil is subjected to the speed-dependent centrifugal pressure in said radial bore, and
a differential pressure piston having a first surface area biased by said lubricating oil under a first pressure influenced by said centrifugal pressure and a second surface area biased by said lubricating oil under a second pressure,
said control piston and said differential pressure piston being housed within said displacement unit.

32. Arrangement as claimed in claim 31, wherein said reset means comprise a reset spring arranged in a spring chamber of said displacement unit.

33. Arrangement as claimed in claim 32, further comprising means for transferring sad control pressure from said control piston to said chamber so as to bias additionally said displacement unit.

34. Arrangement as claimed in claim 33, wherein said means for transferring said control pressure comprise a pressure pipe within said displacement unit, wherein said pressure pipe orifices out of said displacement unit into said spring chamber.

35. Arrangement as claimed in claim 34, wherein said control piston is annular and is effecting its control movement along said pressure pipe.

36. Arrangement as claimed in claim 32, wherein said means for applying an additional force comprises supply means for introducing oil under additional pressure as into said spring chamber.

37. Arrangement as claimed in claim 36, wherein supply means comprise conduit means in said pump housing means which lead to said spring chamber, and valve means in said conduit means for controlling the supply of said additional pressure.

38. Arrangement as claimed in claim 37, wherein said valve means comprise a solenoid valve.

39. Arrangement as claimed in claim 36, further comprising pressure relief means communicating with said spring chamber.

40. An arrangement for speed-dependent pressure regulation of an oil control pump for pumping lubricating oil from an inlet space into a conveying pressure space and from there to an internal combustion engine, comprising
pump housing means;
conveying capacity adjusting means for said lubricating oil supply;
a control piston for generating a control pressure to provide a pressure bias for said conveying capacity adjusting means, said control piston including a control surface area exposed to said conveying pressure;
means for applying an additional force that acts upon said control piston, said force applying means including
rotary means having a radial bore in communication with said lubricating oil so that said lubricating oil is subjected to the speed-dependent centrifugal pressure in said radial bore, and
a differential pressure piston having a first surface area biased by said lubricating oil under a first pressure influenced by said centrifugal pressure and a second surface area biased by said lubricating oil under a second pressure.

41. Arrangement as claimed in claim 40, wherein said conveying capacity adjusting means are displaceable as a displacement unit in said pump housing means and comprise a unit surface area exposed to said conveying pressure.

42. Arrangement as claimed in claim 40, further comprising interrupting means for interrupting said speed-dependent pressure regulation.

43. Arrangement as claimed in claim 42, wherein said interrupting means comprise valve means for interrupting said conveying pressure to be active onto said control surface area.

44. Arrangement as claimed in claim 43, wherein said valve means comprise a solenoid valve.
